(19) United States
(12) Patent Application Publication
(10) Pub. No.: US 2011/0251005 A1
(43) Pub. Date: Oct. 13, 2011

(54) ROLLER CHAIN

(76) Inventors: Detlef Ragnitz, Dassel (DE); Hans-Juergen Kreipe, Bad Wuennenberg (DE)

(21) Appl. No.: 13/082,527

(22) Filed: Apr. 8, 2011

(30) Foreign Application Priority Data
Apr. 13, 2010 (DE) 20 2010 005148.7

(51) Int. Cl. F16G 13/06

(52) U.S. Cl. 474/231

(57) ABSTRACT

A roller chain comprising pins, bushes, rollers, inner fishplates and outer fishplates. Two bushes are connected to each other by at least two inner fishplates and form a chain link. A roller surrounding each bush is mounted rotatably on its respective bush. Adjacent chain links are connected to each other in an articulated manner as a result of each bush being disposed on a pin protruding beyond both ends of the bush, and two pins surrounded by two successive chain links are connected at least by two outer fishplates. At least a part of the bushes comprises a copper alloy. The bushes are produced in a massive forming process.

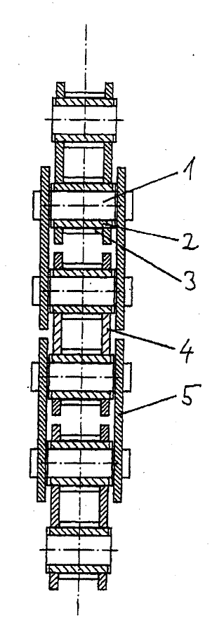

The invention relates to a roller chain having pins, bushes, rollers, inner fishplates and outer fishplates according to the preamble of the claim.

Such chains frequently used for drives are subjected to great wear and tear wherever surfaces are mounted to slide one upon the other, i.e. in particular on the inside of the bushes and on the outer surfaces of the pins abutting thereon if these consist respectively of steel. In order to keep the wear and tear within limits, normally good lubrication is required at the mentioned places. When running dry or in an emergency with such chains, rapid damage to or destruction of a chain and furthermore drastic energy losses occur however.

In order to achieve less susceptibility of such chains to damage even in the case of inadequate lubrication, it is known to coat the pins and/or the bushes with nitrides or DLC, a carbon layer similar to diamond, however these chains also have the disadvantage that, when the chain is running dry, wear and tear occurring at least on one of respectively two surfaces which are sliding one upon the other exceeds a sought small value. In addition, the production costs are increased.

It is also known to equip chains with bronze bushes since these have excellent emergency running properties. However, these bronze bushes have to date been produced by machining, such as turning, as a result of which the manufacturing costs for such chains are considerable and therefore this could not be acceptable practically.

It is therefore the object of the present invention to indicate a roller chain having pins, bushes, rollers, inner fishplates and outer fishplates, in the case of which respectively two bushes are connected to each other by at least two inner fishplates and consequently form a chain link, a roller surrounding each bush being mounted rotatably on these and respectively two successive chain links being connected to each other in an articulated manner as a result of the fact that each bush is disposed on a pin protruding beyond both ends of the bush, and two pins surrounded thus by two successive chain links being connected at least by two outer fishplates, which roller chain has good emergency running properties and can be produced economically.

This object is achieved according to the invention in that at least a part of the bushes consists of a copper alloy and these bushes are produced in a massive forming process. Production of the bushes can be effected such that pieces of a defined length are cut off a rod- or wire-shaped semi-finished product made of a copper alloy and these pieces respectively are subjected to a massive forming or a cold-pressing process in order to form a bush. This can be implemented in a substantially shorter time than that for machining. In addition, no cutting waste occurs during massive forming.

Bronze or brass are used as preferred copper alloys. In order to improve the emergency running properties even further, a small proportion of lead can also be added to the copper alloys.

The other components of the chain can consist of steel, in particular case-hardened, hardened and tempered or stainless steel. However, it can be advantageous in particular also for achieving improved dry running to produce even the rollers from a copper alloy, these rollers being intended to be produced likewise by massive forming for cost reasons.

The invention is explained subsequently in more detail with reference to an embodiment represented in the FIGURE. This shows a section of a roller chain in longitudinal section.

The roller chain illustrated in the FIGURE consists of pins 1, bushes 2, rollers 3, inner fishplates 4 and outer fishplates 5. Respectively two bushes 2 are connected to each other by two inner fishplates 4 which are securely connected to these bushes 2 and form, with these two inner fishplates 4, one chain link, a roller 3 surrounding each bush being mounted rotatably on these. Respectively two successive chain links of this type are connected to each other in an articulated manner as a result of the fact that each bush 2 sits on a pin 1 which protrudes beyond the two ends of this bush 2 and two pins 1, surrounded respectively by one bush 2, of two successive chain links are connected to each other by two outer fishplates 5, respectively one end of the two pins 1 being mounted in a boring at respectively one end of an outer fishplate 5.

According to the invention, at least a part of the bushes consists of a copper alloy such as bronze or brass, and these bushes were cold-extruded seamlessly. The other parts of the roller chain are preferably produced from tempered steel. However, it can be advantageous, since friction also occurs between the bushes 2 and the rollers 1 surrounding these, to produce the rollers 3 also from a copper alloy and to produce these by a massive forming process. As a result, the friction forces between the bushes 2 and the rollers 3 are further reduced and the emergency running properties are improved.

1. A roller chain comprising pins, bushes, rollers, inner fishplates and outer fishplates, wherein two bushes are connected to each other by at least two inner fishplates to form a chain link, a roller surrounding each bush mounted rotatably on its respective bush, and adjacent chain links being connected to each other in an articulated manner as a result of each bush being disposed on a pin protruding beyond both ends of the bush, and two pins surrounded by two successive chain links being connected at least by two outer fishplates, at least a part of the bushes comprising a copper alloy and the bushes being produced in a massive forming process.

2. A roller chain according to claim 1, wherein the copper alloy is bronze.

3. A roller chain according to claim 1, wherein the copper alloy is brass.

4. A roller chain according to claim 1 wherein the copper alloy contains lead.

5. A roller chain according to claim 1 wherein the pins are at least one of case-hardened steel, hardened and tempered steel, and stainless steel.

6. A roller chain according to claim 1, wherein the pins, rollers, inner fishplates and outer fishplates comprise stainless steel.

7. A roller chain according to claim 1, wherein the rollers comprise a copper alloy and are produced in a massive forming process.

8. A roller chain according to claim 2 wherein the copper alloy contains lead.

9. A roller chain according to claim 3 wherein the copper alloy contains lead.

10. A roller chain according to claim 2 wherein the pins are at least one of case-hardened steel, hardened and tempered steel, and stainless steel.

11. A roller chain according to claim 3 wherein the pins are at least one of case-hardened steel, hardened and tempered steel, and stainless steel.

12. A roller chain according to claim 4 wherein the pins are at least one of case-hardened steel, hardened and tempered steel, and stainless steel.

13. A roller chain according to claim 8 wherein the pins are at least one of case-hardened steel, hardened and tempered steel, and stainless steel.

14. A roller chain according to claim 9 wherein the pins are at least one of case-hardened steel, hardened and tempered steel, and stainless steel.

15. A roller chain according to claim 2 wherein the pins, rollers, inner fishplates and outer fishplates comprise stainless steel.

16. A roller chain according to claim 3 wherein the pins, rollers, inner fishplates and outer fishplates comprise stainless steel.

17. A roller chain according to claim 4 wherein the pins, rollers, inner fishplates and outer fishplates comprise stainless steel.

18. A roller chain according to claim 8 wherein the pins, rollers, inner fishplates and outer fishplates comprise stainless steel.

19. A roller chain according to claim 9 wherein the pins, rollers, inner fishplates and outer fishplates comprise stainless steel.

20. A roller chain according to claim 10 wherein the pins, rollers, inner fishplates and outer fishplates comprise stainless steel.
